(19) United States
(12) Patent Application Publication
(10) Pub. No.: US 2013/0242628 A1
(43) Pub. Date: Sep. 19, 2013

(54) SOLAR POWER CONDITIONER

(71) Applicant: DENSO CORPORATION, Kariya-city (JP)

(72) Inventors: Akihiro FUKATSU, Ama-gun (JP); Michitoshi ONODA, Toyohashi-city (JP)

(73) Assignee: DENSO CORPORATION, Kariya-city (JP)

(21) Appl. No.: 13/742,514

(22) Filed: Jan. 16, 2013

(30) Foreign Application Priority Data
Mar. 14, 2012 (JP) 2012-57232

(51) Int. Cl. H02M 7/501

(52) U.S. Cl. CPC H02M 7/501
USPC 363/71

(57) ABSTRACT

A solar power conditioner includes: a synchronous controller; and electric power converters connected in series with each other and arranged at panel groups, respectively. Each electric power converter executes a MPPT control for tracking a maximum power point of an output electric power of the panel group, and converts a voltage and a current of the output electric power of the panel group. The synchronous controller synchronously controls the electric power converters to superimpose converted voltages in series, the converted voltages outputting from the electric power converters, so that the electric power converters output a predetermined pseudo sine wave voltage or a predetermined alternating current voltage.

### CROSS REFERENCE TO RELATED APPLICATION

This application is based on Japanese Patent Application No 2012-57232 filed on Mar. 14, 2012, the disclosure of which is incorporated herein by reference.

### TECHNICAL FIELD

The present disclosure relates to a solar power conditioner for converting a direct current electric power to an alternating current electric power in a solar

### BACKGROUND

A solar power conditioner has been developed by various companies. In order to obtain a generated electric power in a solar cell effectively, a MPPT (maximum power point tracking) control is executed. In the MPPT control, normally, the electric power is maximized by changing an operational voltage since the operational voltage for obtaining the maximum electric power in a solar cell panel is successively varied. The MPPT control is described in JP-A-H11-103538 and JP-B-4527767.

In JP-A-H11-103538, in a solar cell module, each electric power converter executes the MPPT control so that an output current and an output voltage are controlled so as to always maximize the power generation efficiency. A common output current flows through an output terminal of each electric power converter. An output voltage of each electric power converter is automatically adjusted so as to set a ratio of the output voltage of each electric power converter to be equal to a ratio of the maximum electric power of each solar cell module.

In JP-B-4527767, multiple single-phase inverters include a first inverter, in which a first direct current power source having the maximum voltage among direct current power sources inputs an electric power, at least one second converter, connected to a first terminal of the first converter on an alternating current side, and at least one third inverter connected to a second terminal of the first, terminal on the alternating current side.

JP-A-2008-178158 and JP-B2-4527767 (U.S. 2009/0015071) teach that a voltage generated in the solar cell panel is input into a step up and down converter, and the, voltage is charged in a capacitor. Further, a direct current electric power in the capacitor is input into each of the first to third converters so that a voltage of a total of output voltages of these converters is output from an inverter unit. Further, JP-A-2007-58843 teaches that an electric charge accumulated in a capacitor is switched and output in an alternating current form.

In JP-A-H11-103538, the module merely performs the DC-DC conversion. Accordingly, it is necessary to add an electric power converter for performing the DC-AC conversion. Thus, a switching loss increases. In JP-A-2008-178158, and JP-B2-4527767, the voltage converter is arranged to correspond to each solar cell panel, and therefore, the maximum electric power of the solar cell panel is not effectively output. Further, in JP-A-2007-58843, a switching operation of the charge and discharge of the electric charge accumulation capacitor is controller at a frequency higher, by several hundred times to several tens of thousand times than a system frequency. Thus, a switching loss increases.

### SUMMARY

It is an object of the present disclosure to provide a solar conditioner in order to reduce a switching loss and to improve an electric power conversion efficiency of solar cell panels.

According to an aspect of the present disclosure, a solar power conditioner includes: a synchronous controller; and a plurality of electric power converters connected in series with each other, the electric power converter being arranged at a plurality of panel groups, each of which includes one or more solar cell panels, respectively. Each electric power converter executes a maximum power point tracking control for tracking a maximum power point of an output electric power of the panel group. Each electric power converter converts a voltage and a current of the output electric power of the panel group. The synchronous controller synchronously controls the plurality of electric power converters to superimpose converted voltages in series, the converted voltages outputting from the electric power converters, so that the plurality of electric power converters output a predetermined pseudo sine wave voltage or a predetermined alternating current voltage.

In the above conditioner, since the electric power converter is arranged at each panel group having at least one solar cell panel, the converter can maximize the electric power conversion efficiency of the panel group. Further, each electric power converter executes the MPPT control of the output electric power of the panel group, and further, converts the voltage and the current of the output electric power of the panel group. Accordingly, when the synchronous controller superimposes the converted voltages of the electric power converters in series, and synchronously controls the converted voltages so as to output the predetermined pseudo sine wave voltage or the predetermined alternating current voltage, the direct current voltage output from the panel group is directly converted to the output electric power. Thus, the predetermined pseudo sine wave voltage or the predetermined alternating current voltage is effectively output. Therefore, the electric power conversion efficiency of the panel group is much improved.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a solar power conditioner according to a first embodiment;

FIG. 2 is a diagram showing a solar cell panel;

FIG. 3 is a diagram showing another solar cell panel;

FIG. 4 is a circuit diagram showing an electric power converter;

FIG. 5 is a graph showing a voltage dependency of an output electric power of the solar cell panel;

FIG. 6 is a graph showing a PWM signal;

FIG. 7 is a graph showing a PFM signal;

FIG. 8 is a diagram showing a waveform of a pseudo sine wave output from each electric power converter;

FIG. 9 is a diagram showing an on/off timing of each transistor;

FIGS. 10A and 10B are diagrams showing control manners;

FIG. 11 is a diagram showing another control manner;

FIG. 12 is a diagram showing further another control manner;

FIG. 13 is a diagram showing another control manner;

FIG. 14 is a circuit diagram showing another electric power converter;

FIG. 15 is a circuit diagram showing further another electric power converter;

FIGS. 16A and 16B are diagrams showing waveforms of output voltages;

FIG. 17 is a diagram showing a solar power conditioner according to a second embodiment;

FIG. 18 is a diagram showing an output waveform in main parts;

FIG. 19 is a diagram showing a solar power conditioner according to a third embodiment;

FIG. 20 is a diagram showing an output waveform in main parts according to the third embodiment;

FIG. 21 is a diagram showing a shaping way of a waveform;

FIG. 22 is a diagram showing a solar power conditioner according to a fourth embodiment;

FIG. 23 is a diagram showing an output waveform in main parts according to the fourth embodiment;

FIGS. 24A and 24B are diagrams showing a control method of a normal waveform when an output electric power in a panel group is changed temporally;

FIG. 25 is a diagram showing a solar power conditioner according to a fifth embodiment;

FIG. 26 is a diagram showing a solar power conditioner according to a modification of the fifth embodiment; and

FIG. 27 is a diagram showing a solar power conditioner according to a sixth embodiment.

### DETAILED DESCRIPTION

### First Embodiment

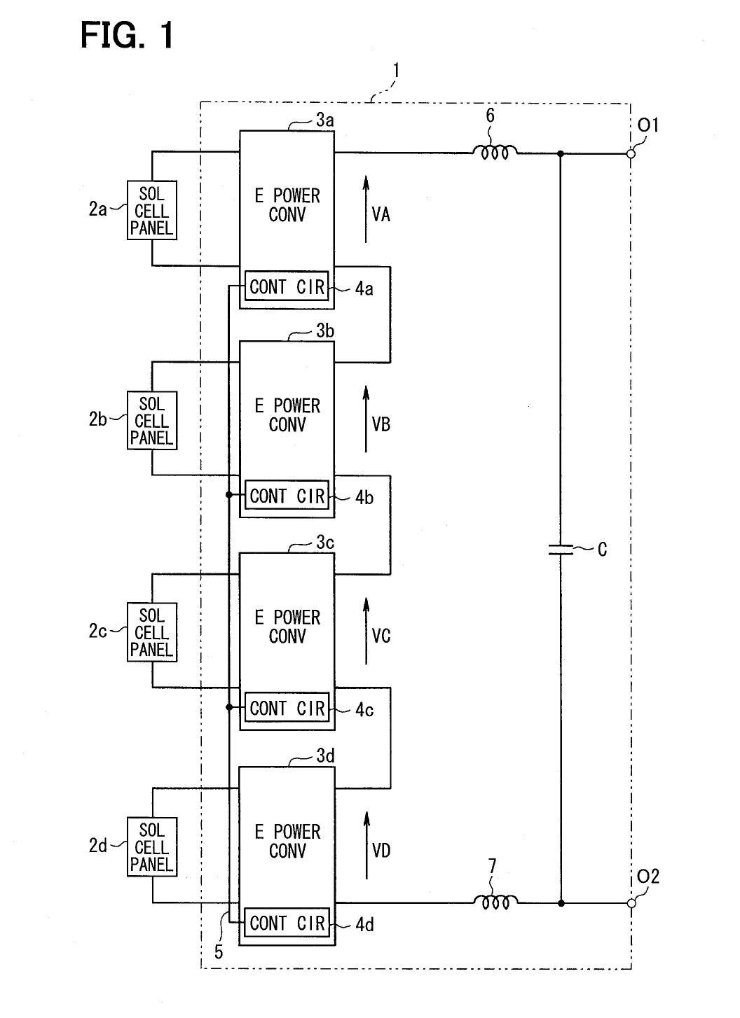

A first embodiment will be explained with reference to FIGS. 1 to 16. A solar power conditioner 1 in FIG. 1 includes an electric power converter 3a-3d for converting a direct current electric power output from one of solar cell panels 2a-2d to an alternating current electric power household use and for sending a system. Each electric power converter 3a-3d is arranged in one of the solar cell panels 2a-2d, and disposed on a backside of the panel 2a-2d.

The electric power converter 3a is connected to an input terminal of the solar cell panel 2a. Similarly, the electric power converter 3b is connected to an input terminal of the solar cell panel 2b, and the electric power converter 3c is connected to an input terminal of the solar cell panel 2c. The electric power converter 3d is connected to an input terminal of the solar cell panel 2d. The output sides of the electric power converters 3a-3d are connected in series with each other.

FIG. 1 shows the output sides of four electric power converters 3a-3d are connected in series with each other so that four step converters are connected. Alternatively, multiple step converters such as two step, three step or five step converters may be connected in series with each other. The number of steps is determined based on the output direct current voltage of each solar cell panel 2a-2d and an amplitude of a pseudo sine wave or an alternating current. A specific example of the determination of the number of steps will be explained later.

Each electric power converter 3a-3d is connected to one of the control circuits (i.e., synchronous controllers) 4a-4d, respectively. The control circuits 4a-4d are connected to each other via a communication line 5. These control circuits 4a-4d synchronously control the electric power converters 3a-3d in a coordinated manner, respectively, so that each electric power converter 3a-3d outputs the electric power. In this case, since the electric power converters 3a-3d are connected in series with each other, the output voltage is output between the output terminals O1, O2 under a condition that outputs from the converters 3a-3d are overlapped with each other.

The communication line 5 provides, for example, a network such as a CAN (controller area network) and a RS485 network. The solar power conditioner 1 may include the communication line 5 as necessary. For example, when the network is provided by a PLC (power line communication), the communication line 5 is not necessary in the conditioner 1.

The output of the electric power converter 3a is connected to the output terminal O1 of the conditioner 1. The output of the electric power converter 3d is connected to the output terminal O2 of the conditioner 1. Thus, a total voltage of “VA+VB+VC+VD” of the electric power converters 3a-3d is output between the output terminals O1, O2.

In the present embodiment each output terminal O1, O2 is connected to a reactor 6, 7 and a capacitor C as an AC filter so as to cut a high frequency component and to shape the waveform. The alternating current voltage output between the output terminals O1, O2 via the AC filter 6, 7, C.

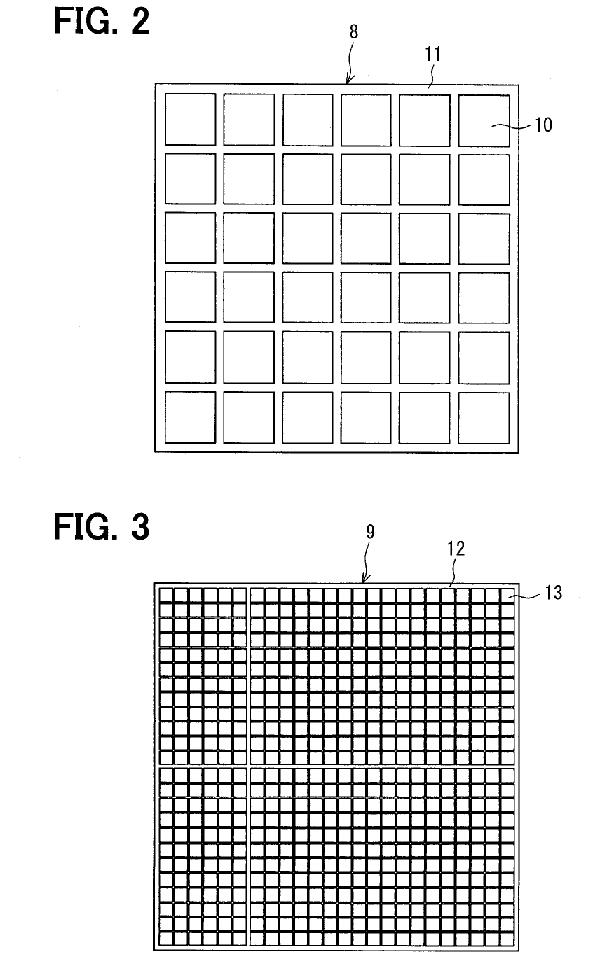

The solar cell panels 2a-2d in FIG. 1 include a crystal-type solar cell panel 8 shown in FIG. 2, a thin-film type solar cell panel 9 shown in FIG. 3, and the like. The crystal-type solar cell panel 8 in FIG. 2 includes a solar cell element 10 having a side of several centimeters to several tens centimeters, which is mounted on a panel 11 having a side of one meter to several meters. On the other hand, the solar cell panel 9 in FIG. 3 includes multiple thin-film type solar cell elements 13 mounted on a glass substrate 12.

Each of the solar cell elements 10, 13 are always used as a combination of multiple elements 10, 13, which are connected to each other. Thus, the solar cell element 10, 13 is rarely used alone. Since the element alone outputs a voltage about several hundreds millivolts at maximum, it is not suitable for large electric power supply. Thus, the elements 10, 13 are connected in series with each other so that the output voltage increases. Thus, the solar cell panel 8, 9 outputs the voltage about several volts to several tens volts. In the present embodiment, the solar cell panel 8, 9 is applied to the solar cell panels 2a-2d.

The electric power converters 3a-3d may have the same circuit construction or different circuit constructions respectively. In the present embodiment the electric power converters 3a-3d have the same circuit construction. The circuit construction of the electric power converter 3a will be explained. Other circuit constructions of the electric power converters 3b-3d are the same.

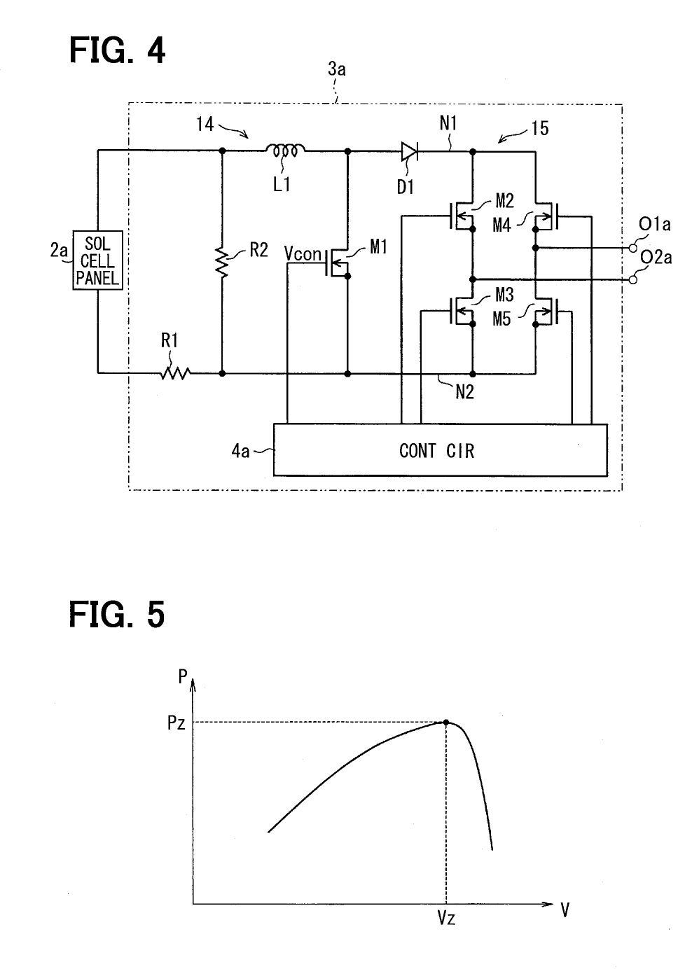

As shown in FIG. 4 of the circuit construction of the electric power converter 3a, the converter 3a includes a voltage conversion element 14 connected to the solar cell panel 2a, and a polarity conversion element 15 arranged on a later step from the voltage conversion element 14. The voltage conversion element 14 includes a step up circuit having a reactor L1, a transistor M1 and a diode D1. The transistor M1 is a N channel type power MOSFET. The voltage conversion element 14 converts an output direct current voltage according to a pulse signal when the pulse signal is applied to a control terminal of the transistor M1 from a control circuit 4a.

The resistor R1 shown in FIG. 4 provides a current detector for measuring an output current of the solar cell panel 2a. The resistor R2 provides a voltage detector for measuring an output voltage of the solar cell panel 2a. According to detection signals from the voltage detector and the current detector, the control circuit 4a executes the MPPT control. For example, the control circuit 4a controls the duty ratio and/or the cycle of the pulse signal to be applied to the control terminal of the transistor M1.

FIG. 5 shows a characteristic of a general solar cell panel between an electric power P and a voltage V. When the output operation voltage increases, the output electric power also increases. After the output operation voltage reaches a predetermined voltage, the current supply amount is reduced and therefore, the output electric power is also reduced. Accordingly, as shown in FIG. 5, the electric power P reaches the maximum electric power Pz at the maximum output operation voltage Vz.

In the present embodiment, the control circuit 4a varies temporally the duty ratio and/or the period of the pulse signal to be applied to the control terminal of the transistor M1 so that the control circuit 4a executes a MPPT (maximum power point tracking) control in order to set the output voltage of each solar cell panel 2a-2d to be the maximum output operation voltage Vz or a near value thereof. Thus, the generated electric power of the solar cell panel 2a is effectively obtained.

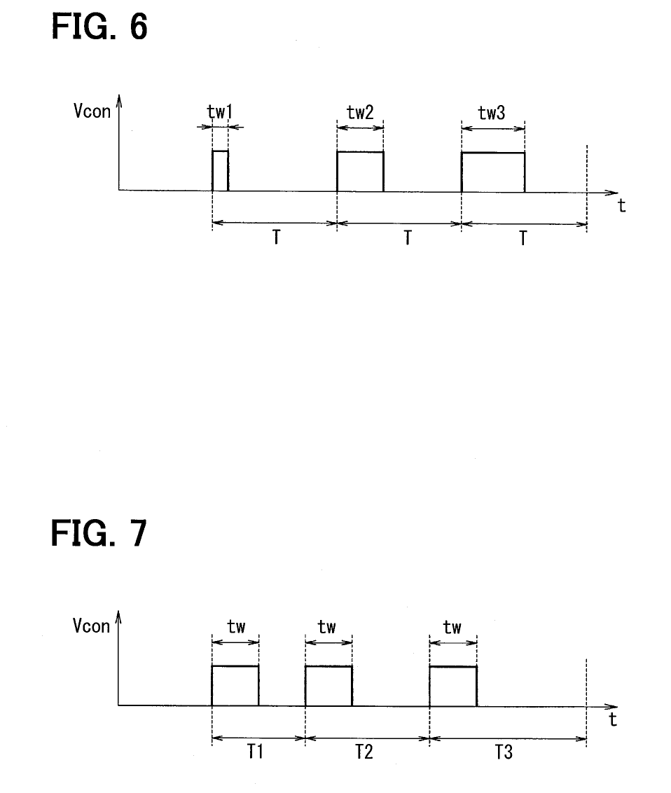

FIGS. 6 and 7 show examples of a pulse signal for executing the control to be applied to the control terminal of the transistor M1. FIG. 6 shows an example of the pulse width modulation (PWM) signal having a constant cycle T and various pulse widths tw1, tw2, tw3 and so on. FIG. 7 shows a pulse frequency modulation (PFM) signal having a constant pulse width tw and various frequencies T1, T2, T3 and so on.

In general, when the rising edge waveform and the falling edge waveform are smoothed with using the soft switching technique, the constant pulse width tw or the varied pulse widths wt1, tw2, tw3 are set to be equal to or larger than a predetermined value. Thus, in this case, the pulse frequency modulation signal having the constant pulse width tw may be used. Here, when the load is small, it is necessary to control=the frequency lower than a predetermined value. In this case, the pulse width modulation signal may be used and the signal has the constant frequency in a non audible frequency range, not in an audible range. For example, the constant frequency is set to be slightly higher than 20 kHz. Here, the audible range represents the frequency smaller than 20 kHz.

The maximum output electric power of the solar cell panel 2a is varied according to the influence of solar radiation intensity, which depends on weather, solar altitude, shadow and the like. Accordingly, the control circuit 4a detects the voltage and the current with using the resistors R1, R2 so that the electric power is monitored. Thus, the control circuit 4a controls the panel 2a to obtain the maximum electric power. Here, a capacitor (not shown) may be arranged between the output nodes N1, N2. Alternatively, the capacitor may not be arranged between the output nodes N1, N2.

The polarity conversion element 15 includes transistors M2 to M5. These transistors M2-M5 provide a full bridge connection having four N channel power MOSFETs. In FIG. 4, when the control circuit 4a controls the transistor M2 to turn off, the transistor M3 to turn on, the transistor M4 to turn on and the transistor M5 to turn off, the positive polarity voltage is output between the output terminals O1a, O2a. Further, when the control circuit 4a controls the transistor M2 to turn on, the transistor M3 to turn off, the transistor M4 to turn off and the transistor M5 to turn on the negative polarity voltage is output between the output terminals O1a, O2a. Although the output terminals O1a, O2a are not shown in FIG. 1, the electric power converters 3a-3d outputs the voltages VA-VD between output terminals O1a, O2a, respectively.

When the control circuits 4a controls the transistors M3, M5 to turn on and the transistors M2, M4 to turn off, the electric power converters 3a-3d outputs almost zero volt between output terminals O1a, O2a, respectively. Accordingly, the converter 3a can output the pulse voltage having the positive polarity or the pulse voltage having the negative polarity between the output terminals O1a, O2a.

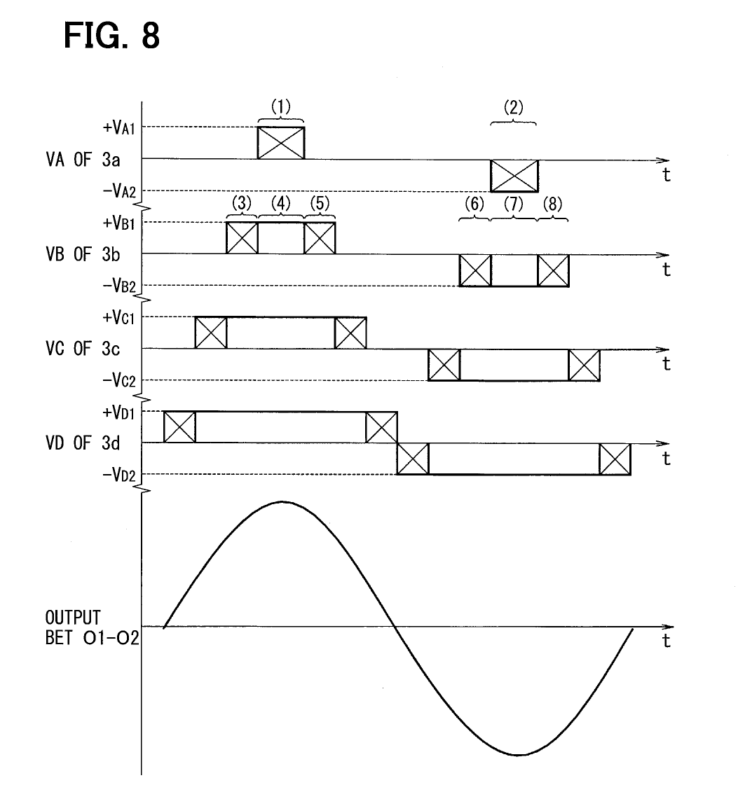

When the control circuits 4a-4d control the transistors M1-M5 to turn on and off, each electric power converter 3a-3d outputs a voltage shown in FIG. 8. Here, in a time domain defined by a cross-out box (i.e., in a time domain defined as (1), (2), (3), (5), (6) and (8)), at least one of the transistors M2-M5 is controlled to switch on and of so that a part of the voltage having a pseudo sine waveform is output.

In a time domain sandwiched between the cross-out boxes (i.e., in a time domain defined as (4) and (7)), the pulse voltage having the positive or negative polarity and a constant voltage in a predetermined time interval is output.

For example, the output voltage VA of the electric power converter 3a is switched between zero volt and the positive amplitude voltage of +VA1 at high speed in the time domain defined as (1). Then, the output voltage VA is set to be zero. After that, the output voltage VA is switched between zero volt and the negative amplitude voltage of −VA2 at high speed in the time domain defined as (2). Thus, in the time domains defined as (1) and (2), the electric power converter 3a outputs the pulse voltage having the cycle shorter than the pulse voltage in the time domain defined as (4) or (7).

The output voltage VB of the electric power converter 3b is switched between zero volt and the positive amplitude voltage of +VB1 at high speed in the time domain defined as (3) so that the converter 3b outputs the short pulse voltage. Just after that, the converter 3b outputs the pulse voltage having the constant voltage of the positive amplitude voltage of +VB1 for a predetermine time interval, which is defined as the time domain of (4). Specifically, the predetermined time interval is equal to the short pulse voltage output period of the converter 3a, i.e., the time domain defined as (1). Just after that, the output voltage VB of the electric power converter 3b is switched between zero volt and the positive amplitude voltage of +VB1 at high speed in the time domain defined as (5) so that the converter 3b outputs the short pulse voltage. Then, the output voltage VB is set to be zero.

After that, the output voltage VB is switched between zero volt and the negative amplitude voltage of −VB2 at high speed in the time domain defined as (6) so that the converter 3b outputs the short pulse voltage for the pseudo sine wave. Just after that, the converter 3b outputs the pulse voltage having the constant voltage of the negative amplitude voltage of −VB2 for a predetermine time interval, which is defined as the time domain of (7). Specifically, the predetermined time interval is equal to the short pulse voltage output period of the converter 3a, i.e., the time domain defined as (2). Just after that, the output voltage VB of the electric power converter 3b is switched between zero volt and the negative amplitude voltage of −VB2 at high speed in the time domain defined as (8) so that the converter 3b outputs the short pulse voltage for the pseudo sine wave. Thus, the converter 3b outputs the pulse voltage and the short pulse voltage. Further, as shown in FIG. 8, the converters 3c, 3d also output the pulse voltage and the short pulse voltage as the output voltages VC, VD, respectively.

The power conditioner 1 superimposes in series and synchronizes the output voltages VA-VD between the output terminals O1a, O2a of the electric power converters 3a-3d so that the conditioner 1 outputs the pseudo sine wave. Thus the conditioner 1 outputs the alternating current voltage having almost the sine waveform between the output terminals O1, O2 via the AC filter, provided by the reactors 6, 7 and the capacitor C.

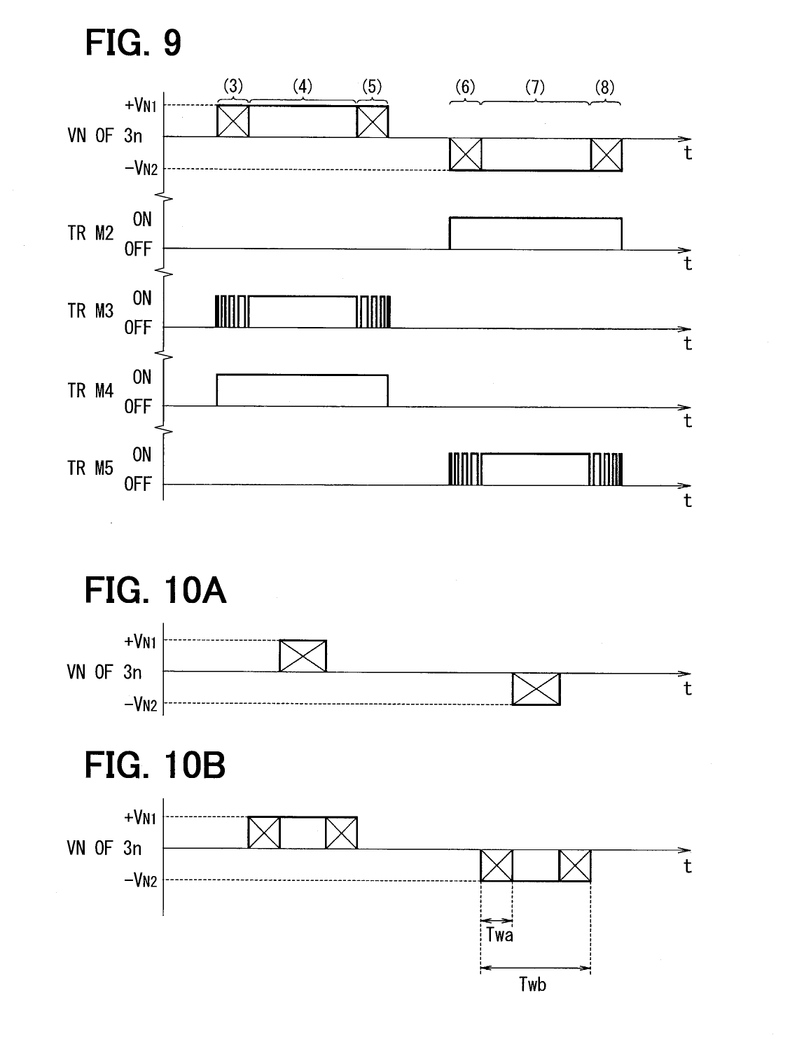

FIG. 9 shows an on/off control method of the transistor in the electric power converter. When the electric power converter 3n outputs the pulse voltage and the short pulse voltage having the amplitude of the positive amplitude voltage of +VN1 as the output voltage VN, as shown on a left side of FIG. 9, the transistors M2, M5 turn off, the transistor M4 turns on, and the transistor M3 switches between the on state and the off state so that the converter 3n executes the switching control. Here, the suffix “n” represents one of “a,”“b,”“c,” and “d,” and the suffix “N” represents one of “A,”“B,”“C,” and

For example, in the time domain of (3) and (5), the converter 3n outputs the short pulse voltage having the output voltage VN between zero volt and the positive amplitude voltage of +VN1. Under a condition that the transistors M2, M5 are in the off state, and the transistor M4 is in the on state, the transistor M3 switches between the on state and the off state at high speed.

In the time domain of (4), when the converter 3n outputs the short pulse voltage between zero volt and the positive amplitude voltage of +VN1 as the output voltage VN, the transistors M1, M5 turn off, the transistor M4 turns on, and the transistor M3 turns on and off at high speed. In this case, the output voltage of the transistor M3 provides a part of the pseudo sine wave in the time domains of (3) and (5). Accordingly, in the time domain of (3), as time elapses from the starting time to the ending time of the time domain of (3), the on time width is gradually enlarged. In the time domain of (5), as time elapses from the starting time to the ending time of the time domain of (5), the on time width is gradually reduced.

When the electric power converter 3n outputs the pulse voltage and the short pulse voltage having the amplitude of the negative amplitude voltage of −VN2 as the output voltage VN, as shown on a right side of FIG. 9, the transistors M3, M4 turn off, the transistor M2 turns on, and the transistor M5 switches between the on state and the off state at high speed.

In this case, the output voltage of the transistor M5 provides a part of the pseudo sine wave in the time domains of (6) and (8). Accordingly, in the time domain of (6), as time elapses from the starting time to the ending time of the time domain of (6), the on time width is gradually enlarged. In the time domain of (8), as time elapses from the starting time to the ending time of the time domain of (8), the on time width is gradually reduced.

For example, when the control circuits 4a-4d execute the synchronization control with using the converters 3a-3d, so that the pseudo sine wave is generated to provide the alternating current voltage having the frequency of 50 Hz as a target signal, the one cycle of the pseudo sine wave is 20 micro seconds. Accordingly, each converter 3a-3d outputs the pulse positive voltage or the pulse negative voltage having one cycle of a few micro seconds, which is shorter than 20 micro seconds. The pulse positive voltages or the pulse negative voltages from the converters 3a-3d are superimposed in series and synchronized according to the control manner of the control circuits 4a-4d.

Each control circuit 4a-4d as a controller controls one of the electric power converters 3a-3d, respectively. In this case, one control circuit 4a-4d communicates with another control circuit 4a-4d, which is connected to the one control circuit 4a-4d via the communication line 5 so that the one control circuit 4a-4d controls the conversion electric power of one electric power converter 3a-3d. Accordingly, the one control circuit 4a-4d can conform the electric power conversion condition of other control circuits 4a-4d, and the one control circuit 4a-4d adjusts the electric power conversion condition of the electric power converter 3a-3d in the one control circuit 4a-4d. Thus the electric power conversion efficiency is improved.

(First Control Method)

As shown in FIG. 10A, the electric power converter 3n may change the positive amplitude voltage +VN1 as the output voltage VN. Alternatively, the electric power converter 3n may change the negative amplitude voltage −VN2 as the output voltage VN so that the converter 3n converts the electric power. As shown in FIG. 10B, the electric power converter 3n may change the time width Twa, in which the converter 3n executes high speed switching control when the converter 3n outputs the short pulse voltage. Alternatively, the converter 3n may change a total time width Twb of outputting the pulse voltage and the short pulse voltage.

When the converter 3n actually controls the output voltage, the converter 3n may set the time width Twa and/or the-total time width Twb to be constant, and the converter 3n may change the amplitude voltage of +VN1 and −VN2, so that the converter 3n converts and outputs the output voltage. Alternatively, the converter 3n may set the amplitude voltage of +VN1 and −VN2 to be constant, and the converter 3n may change the time width Twa and/or the total time width Twb, so that the converter 3n converts and outputs the output voltage. Thus, since the number of parameters to be adjusted is reduced control circuit 4n easily controls the converter 3n.

(Second Control Method)

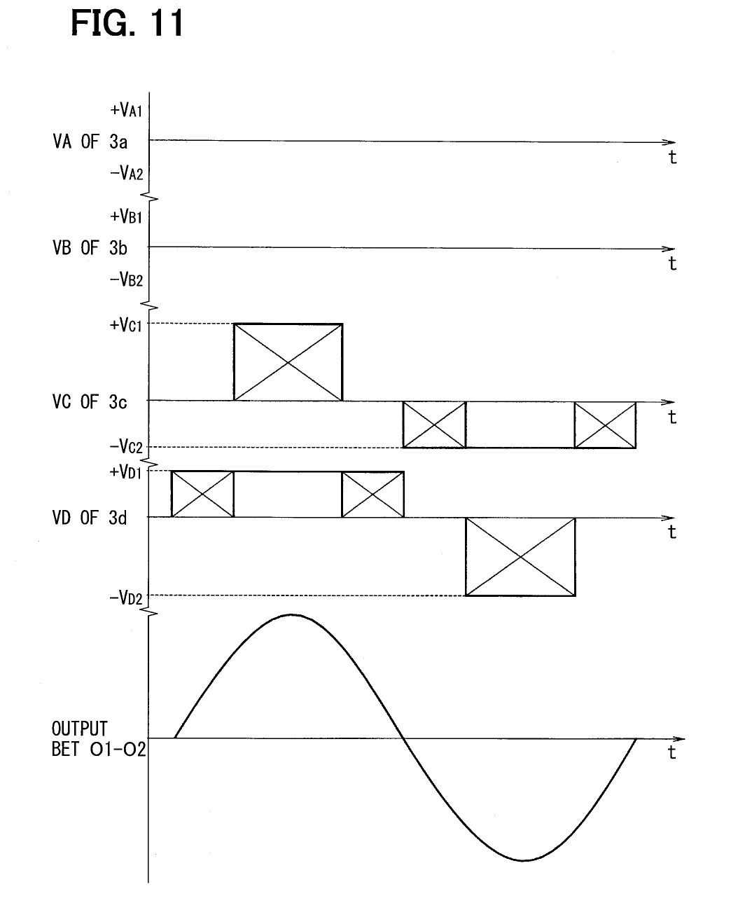

FIG. 11 shows a second control method of the converter 3n when the sun light shines on only the solar cell panels 2c, 2d, and does not shine on the solar cell panels 2a, 2b. In this case, the converters 3a, 3b does not substantially output the generated electric power, but the converters 3c, 3d output the generated electric power. Thus, even if the generated electricity by the converters 3a, 3b is reduced, the converters 3c, 3d generate the electricity. Thus, the generated electric power by the converters 3c, 3d is shaped to be a part of the pseudo sine wave voltage, and then, the shaped electric power of each converter 3c 3d is superimposed in series so that the voltage is output.

In the above case, the voltage between ends of the resistor R1, R2 is measured so that the voltage and the current in the solar cell panel 2a-2d are detected. Thus, based on the voltage and the current in the panel 2a-2d, it is determined whether the sun light is blocked, i.e., whether the panel is in the light interception state. When a light interception detection circuit detects the light interception, only the panel, in which the circuit does not detect the light interception, may convert the output voltage. In this case, the voltage conversion element 14 and the polarity conversion element 15 corresponding to the solar cell panel, in which the circuit detects the light interception, may not be operated, and only the electric power conversion portion corresponding to the solar cell panel, in which the circuit does not detect the light interception, may be operated. In this case, the switching loss of the transistors M1-M5 for providing the voltage conversion element 14 and the polarity conversion element 15 is reduced, so that the electric power conversion efficiency is improved. Thus, the alternating current voltage between the output terminals O1, O2 having a sine waveform is output.

(Third Control Method)

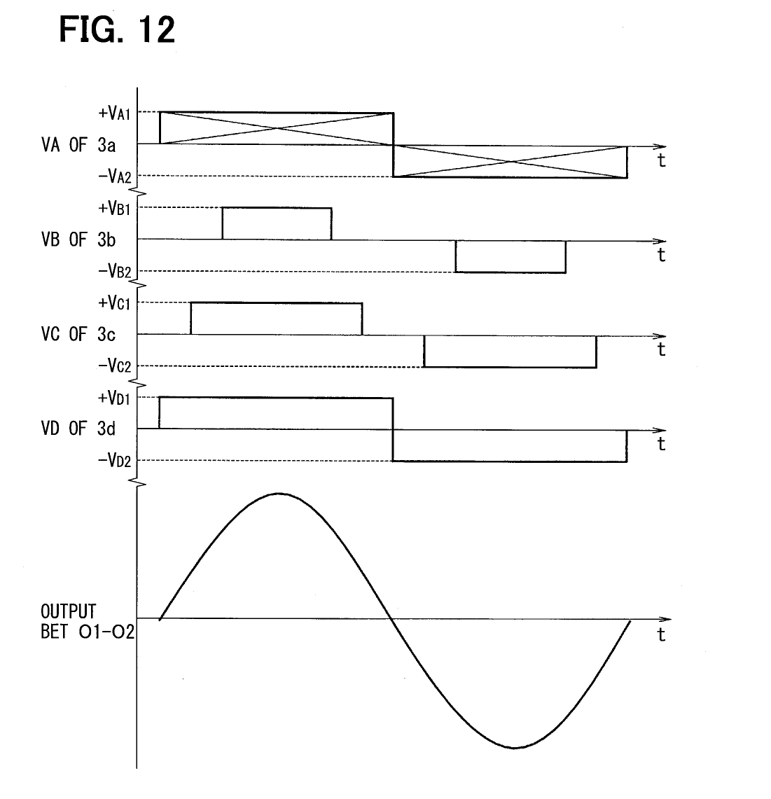

FIG. 12 shows a third control method of the converter 3n. In FIG. 12, only the electric power converter 3a among the converters 3a-3d outputs the short pulse voltage. Accordingly, in the other converters 3b-3d, each transistor M2-M5 is switched so that the transistor M2-M5 outputs the pulse voltage as a constant voltage in predetermined time interval. Thus, the functions of the converters 3a-3d are preliminary determined such that the converter 3a outputs the short pulse voltage, and the converters 3b-3d output the pulse voltage. Thus, when the transistors in only a part of the converters 3a-3d execute the high speed switching operation, it is not necessary to prepare a complicated control method. The alternating current voltage between the output terminals O1, O2 having a sine waveform is output.

(Fourth Control Method)

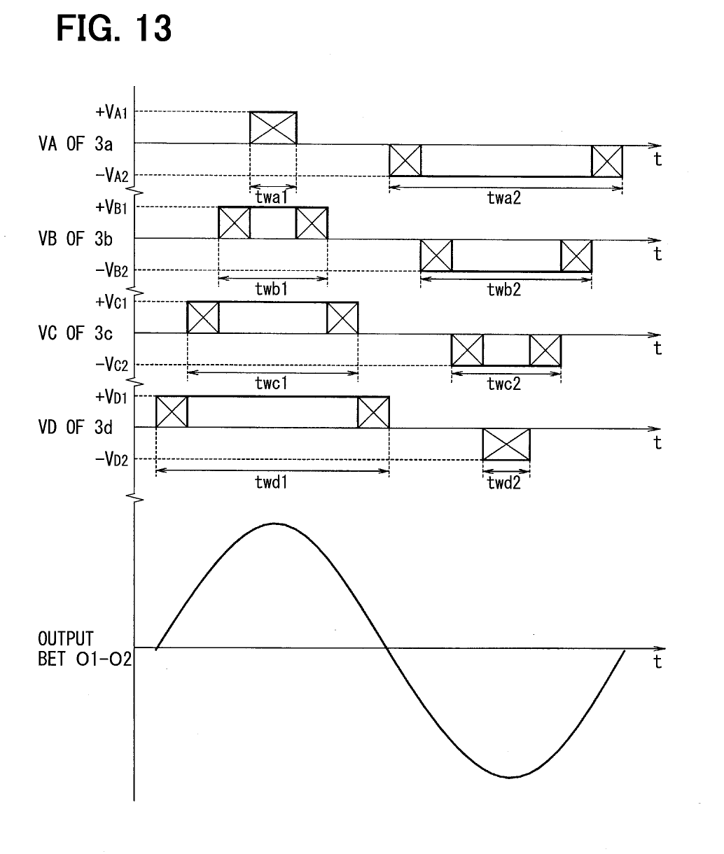

FIG. 13 shows a fourth control method of the converter 3n. The pulse voltage output time width twa1 of the positive amplitude voltage of +VA1 may be different from the pulse voltage output time width twa2 of the negative amplitude voltage of −VA2.

The relationship between the pulse voltage output time widths twb1, twb2 in the converter 3b, the relationship between the pulse voltage output time widths twc1, twc2 in the converter 3c and the relationship between the pulse voltage output time widths twd1, twd2 in the converter 3d are also the same as the above relationship between the pulse voltage output time widths twa1, twa2 in the converter 3a. Specifically, based on the control of the control circuits 4a-4d, all of the output voltages VA-VD of the converters 3a-3d are superimposed so that the pseudo sine wave is obtained. Thus, the alternating current voltage between the output terminals O1, O2 having a sine waveform is output.

(First Modification)

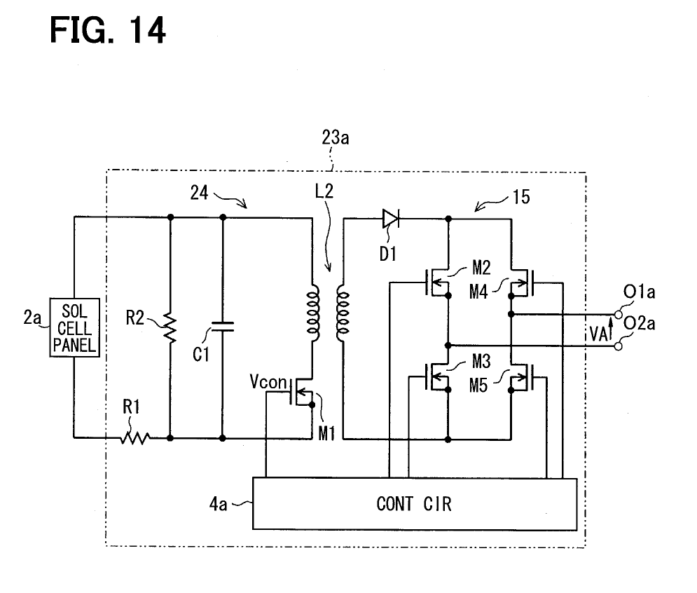

FIG. 14 shows an electric power converter 23a instead of the converter 3a as a modification of the electric power converter. The converter 23a includes a voltage conversion element 24 and the polarity conversion element 15.

The voltage conversion element 24 includes a capacitor C1, a transformer L2 and a transistor M1 into which the solar cell panel 2a outputs an electric power. The capacitor C1 is connected to an output side of the panel 2a. A primary side of the transformer L2 and a series circuit of the transistor M1 are connected between both ends of the capacitor C1. A secondary side of the transformer L2 is connected to a diode D1 for rectification, and further connected to the polarity conversion element 15 after the diode D1. Accordingly, the voltage conversion element 24 is provided by an input/output isolation type circuit. When the transistor M1 is operated to execute an on/off control, the maximum electric power point is searched, and the output of the element 24 is controlled. The polarity conversion element 15 on a latter step of the voltage conversion element 24 converts the polarity of the output voltage, so that the converter 23a outputs a part of the pseudo sine wave between the output terminals O1a, O2a.

(Second Modification)

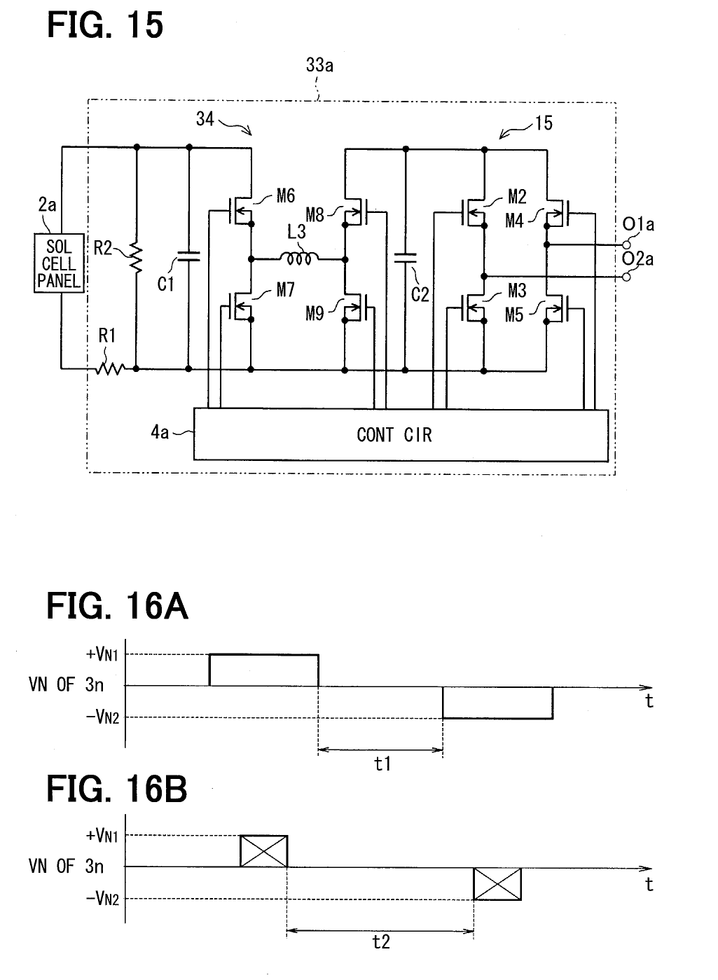

FIG. 15 shows an electric power converter 33a instead of the converter 3a as a modification of the electric power converter. The converter 33a includes a voltage conversion element 34 and the polarity conversion element 15. The capacitor C1 is connected between terminals of the solar cell panel 2a. Further, the transistors M2, M3 of the polarity conversion element 15 are connected in parallel to the capacitor C2.

The voltage conversion element 34 includes transistors M6, M7 connected in series between both ends of the capacitor C1, transistors M8, M9 connected in series with the capacitor C2, and a reactor L3 between a first common connection point and a second common connection point. The first common connection point is disposed between the transistors M6, M7, and the second common connection point is disposed between the transistors M8, M9.

The control circuit 4a controls the transistors M6-M9 to turn on and off, so that the output electric power of the solar cell panel 2a is accumulated in the reactor L3 temporally. The voltage and the current of the accumulated electric power in the reactor L3 is converted, and then, the converted power is input into the polarity conversion element 15. The polarity conversion element 15 converts the positive polarity and the negative polarity, and then, the element 15 outputs a part of the pseudo sine wave between the output terminals O1a, O2a. In this case, the output voltage of the solar cell panel 2a can be controlled to increase and to decrease. Thus, the voltage is much stabilized.

FIG. 16 shows a waveform of the output voltage. The time interval t1, t2, during which the electric power converter 3n does not output the voltage, exists between the switching operations of each transistor M6-M9. Since the capacitors C1, C2 are attached to the electric power converter 33a in FIG. 15, the converter 33a can output the pulse voltage and the short pulse voltage just after the time interval t1, t2. Alternatively, the converter 33a may not include the capacitors C1, C2. Alternatively, the converter 33a may include only one of the capacitors C1, C2. Alternatively, the converter 3a shown in FIG. 4 and the converter 23a shown in FIG. 14 may include the capacitors C1, C2, which are arranged at the same position as in FIG. 15.

In the above embodiment, each solar cell panel 2a-2d includes one electric power converter 3a-3d. The converter 3a-3d follows the maximum electric power point of the output voltage from the panel 2a-2d. Therefore, the electric power conversion efficiency is much improved. Further, the dimensions of the AC filter 6, 7 connected between the output terminals O1, O2 is minimized.

Since each converter 3a-3d includes one polarity conversion element 15, each converter 3a-3d can convert the positive polarity and the negative polarity of the pulse voltage. Thus, the control circuit 4a-4d can execute the waveform shaping process with high degree of freedom.

### Second Embodiment

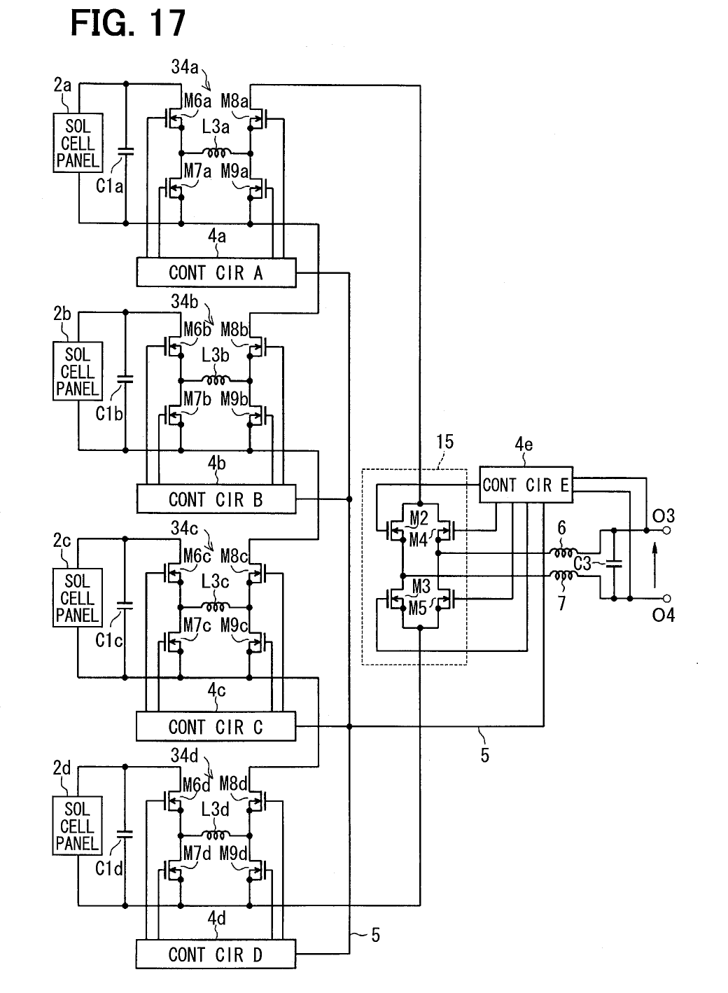

FIG. 17 shows a solar power conditioner according to a second embodiment. The differences between the second embodiment and the above first embodiment are such that only one polarity conversion element is arranged in the conditioner, the polarity conversion element corresponding to all of the voltage conversion elements, and being arranged on the latter step of the voltage conversion element. The conditioner according to the present embodiment will be explained with using the construction of the conditioner according to the second modification of the first embodiment. Specifically, the conditioner according to the present embodiment includes the voltage conversion element 34 and the polarity conversion element 15. In the following explanation, the suffix “a” to “d” is added to the voltage conversion element 34, the transistor M6-M9 and the capacitor C1.

As shown in FIG. 17, a secondary side of each voltage conversion element 34a-34d is connected in series with each other. A voltage obtained by a series connection of the voltage conversion elements 34a-34d is totally input into the polarity conversion element 15. The polarity conversion element 15 is connected to the control circuit 4e. The control circuit 4e sets the control signal to be applied to the transistors M2-M5 in the polarity conversion element 15 in accordance with the detection voltage between the series output terminals O3, O4. The polarity conversion element 15 converts polarity of the input voltage (i.e., the conversion voltage obtained by the series connection of the voltage conversion elements 34a-34d) and outputs the converted voltage.

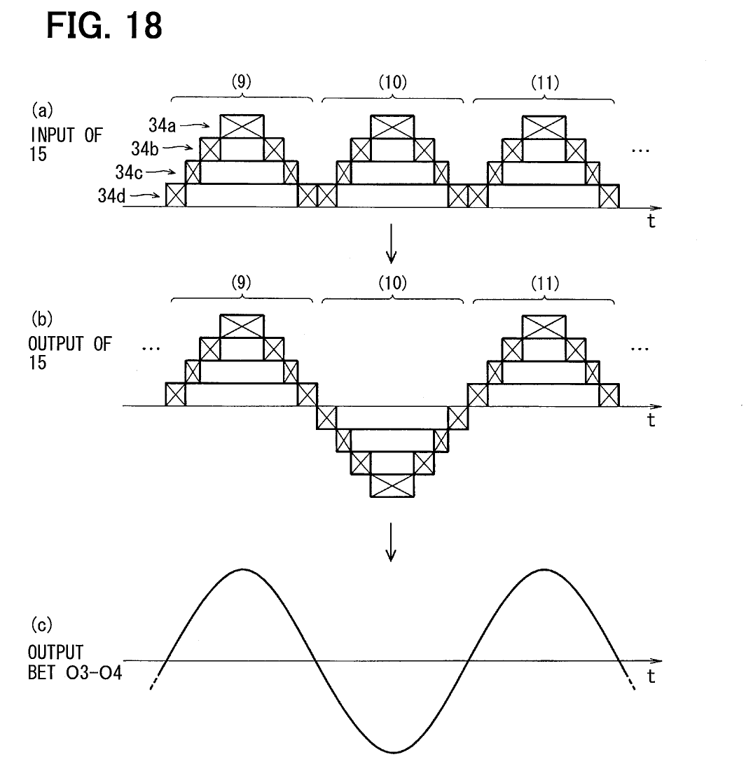

When each control circuit 4a-4d controls the output voltage of the voltage conversion element 34a-34d, the voltage output shown in (a) of FIG. 18 is obtained. Since each voltage conversion element 34a-34d outputs a part of the pseudo sine wave voltage having the positive polarity, when these output voltages are superimposed in series with each other, the voltage waveform (i.e., the positive polarity waveform of the pseudo sine wave) shown in (a) of FIG. 18 is input into the polarity conversion element 15.

The control circuit 4a reverses the polarity of the pseudo sine wave of the input voltage into the polarity conversion element 15 every half cycle. In this case, the control circuit 4e outputs the voltage with the positive polarity in a time domain of (9) in (a) and (b) of FIG. 18. In a time domain of (10), the control circuit 4e converts the voltage to the negative polarity. Further, in a time domain of (11), the control circuit 4e maintains the positive polarity, and outputs the positive polarity, voltage. The time domains of (9) to (11) are set according to the detection voltage between the output terminals O3, O4. Under this control, the polarity conversion element 15 outputs the pseudo sine wave. When the polarity conversion element 15 outputs the pseudo sine wave, the element 15 outputs the alternating current voltage between the output terminals O3, O4 through the AC filter 6, 7, C3. Alternatively, the voltage conversion element 14, 24 may be used as the voltage conversion element 34.

### Third Embodiment

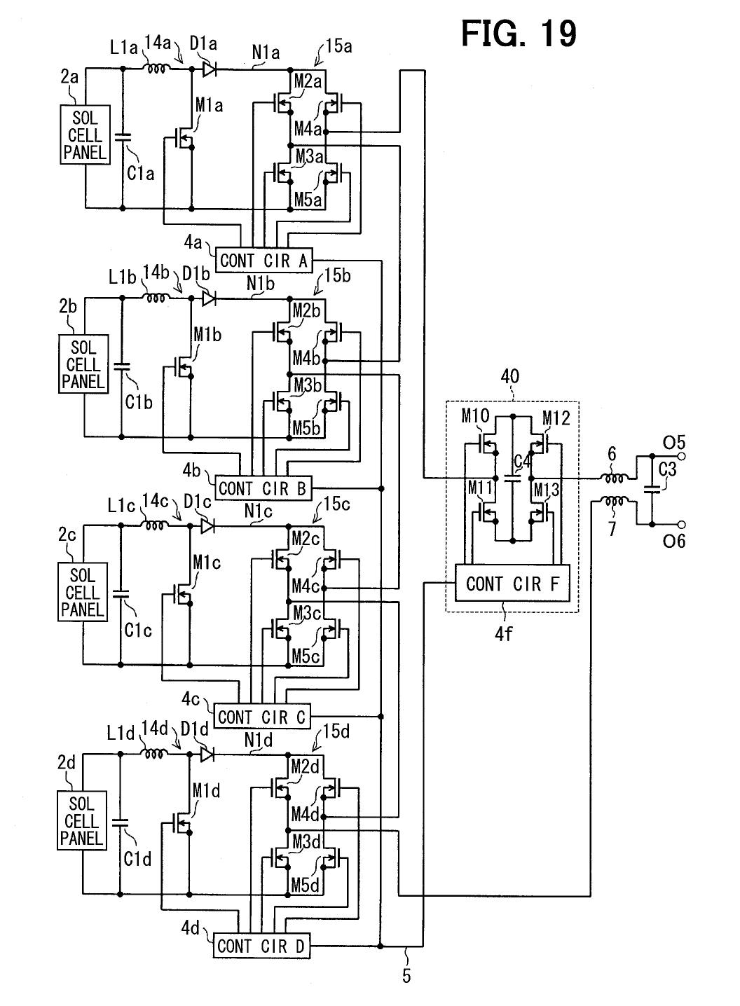

FIG. 19 shows a solar power conditioner according to a third embodiment. The differences between the third embodiment and the above embodiments are such that a polarity conversion element is arranged on a latter step of each voltage conversion element. Further, one waveform shaping element is arranged on a latter step of all of the polarity conversion elements.

In the present embodiment, the voltage conversion element 14, and the polarity conversion element 15 are used. In the following explanation, the suffix “a” to “d” is added to the voltage conversion element 14, the polarity conversion element 15, the transistor M6-M9, the reactor L1, the capacitor C2, the diode D1 and the node B1, which are provided in each solar cell panel 2a-2d

The voltage conversion element 14a-14d and the polarity conversion element 15a-15d according to the present embodiment are the same as the first embodiment. A voltage obtained by the series connection of the output of the polarity conversion elements 15a-15d is totally input into one waveform shaping element 40.

The waveform shaping element 40 includes the transistors M10-M13, the capacitor C4, and the control circuit 4f, which is connected to the communication line 5. The transistors M10-M13 provide the full bridge connection. the capacitor C4 is connected between a first common connection point and a second common connection point. The first common connection disposed between the transistors M10, M12, and the second common connection point is disposed between the transistors M11, M13. One terminal of a series connection circuit of the polarity conversion elements 15a-15d is connected to a common connection point between the transistors M10, M11. The other terminal of the series connection circuit is connected to an input node of the AC filter 6, 7, C3. The voltage of the series connection circuit provides the input voltage of the waveform shaping element 40.

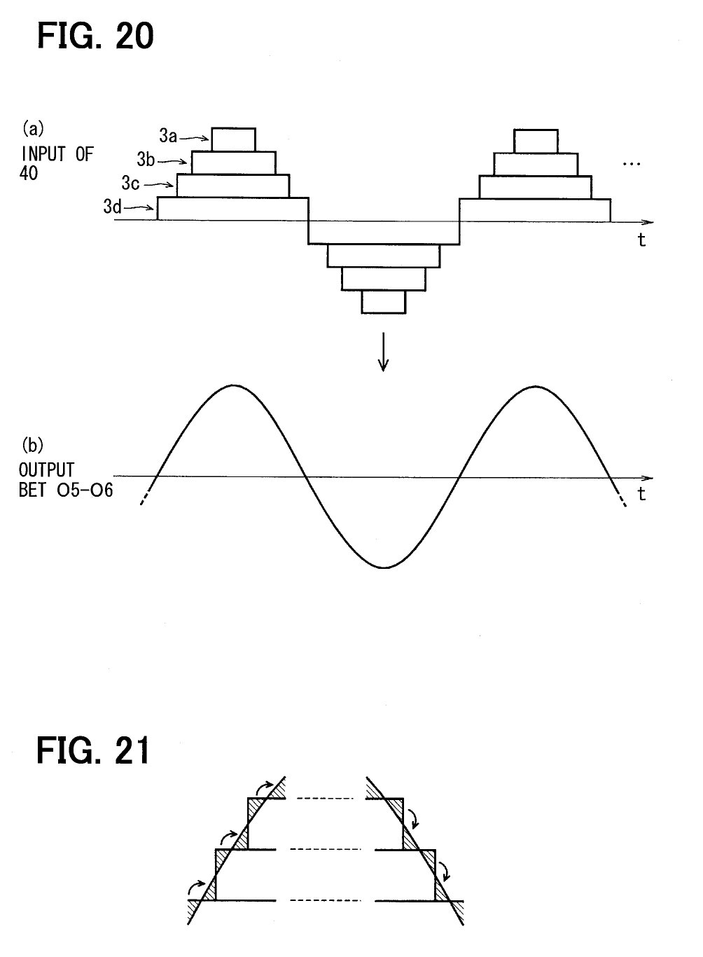

The voltage conversion elements 14a-14d and the polarity conversion elements 15a-15d convert the voltage, so that the voltage waveform shown in (a) of FIG. 20 is obtained. Here, the pulse voltage waveform in (a) of FIG. 20 is the pulse voltage (i.e., the single pulse rectangular wave) having the constant voltage in a predetermined time interval. The input voltage of the waveform shaping element 40 provides a stepwise voltage, which is prepared by superimposing the pulse voltage having the single pulse rectangular wave.

As shown in FIG. 21, the waveform shaping element 40 accumulates the electricity in the capacitor C4, the electricity being prepared based on the rising edge rectangular voltage of the pulse voltage (i.e., the single pulse rectangular wave) in the stepwise voltage as the input voltage. Further, the element 40 adds the voltage just after the accumulation so that the element 40 shapes a voltage to be a target alternating current voltage waveform. When the waveform shaping element 40 detects the rising voltage of the pulse voltage as the single pulse rectangular wave, the transistors M10, M13 turn on, and the transistors M11, M12 turn off, so that the electricity is stored in the capacitor C4. then, when the element 40 detects reduction of the voltage waveform gradient, the transistors M10, M13 turn off, and the transistors M11, M12 turn on, so that the electricity is discharged to the output side, and the voltage is added to the latter voltage in order to approximate the alternating current voltage waveform as a target voltage waveform. Thus, as shown in (b) of FIG. 20, the alternating current voltage is obtained between the output terminals O5, O6.

### Fourth Embodiment

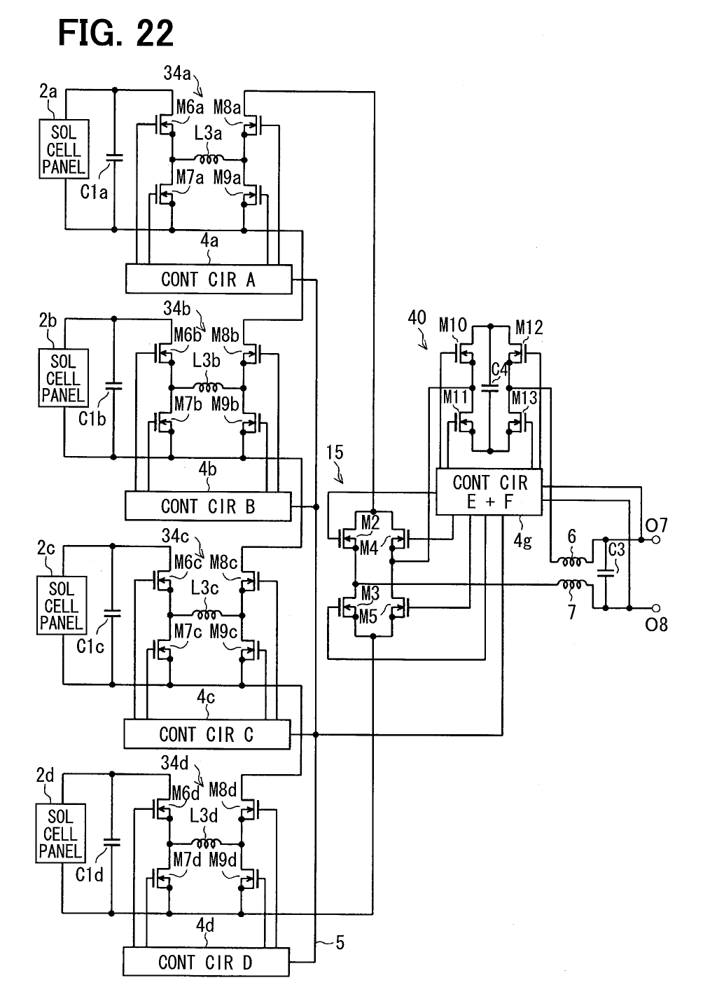

FIGS. 22 to 24 show a solar power conditioner according to a fourth embodiment. The circuit construction according to the present embodiment is provided by a combination of the second and third embodiments.

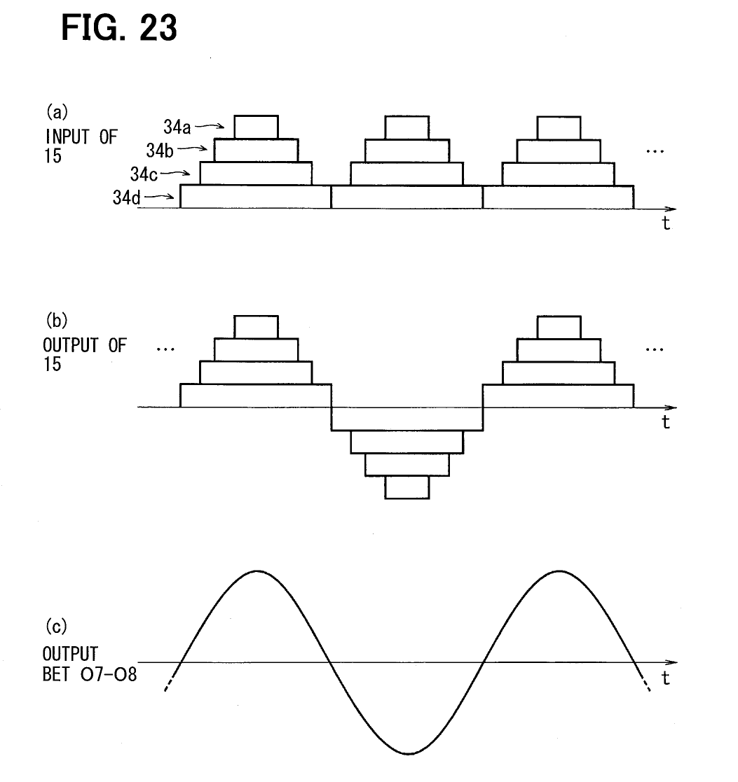

As shown in FIG. 22, an output from a circuit, which is provided by the series connection of all of the voltage conversion elements 34a-34, is inputted into the polarity conversion element 15. As shown in (a) of FIG. 23, when the stepwise voltage having the positive polarity is input into the polarity conversion element 15, the polarity conversion element 15 converts the polarity to the negative polarity every half cycle, as shown in (b) of FIG. 23. After the waveform shaping element 40 shapes the waveform, the polarity conversion element 15 outputs the voltage between the output terminals O7, O8 via the AC filter 6, 7, C3. Thus, the alternating current voltage shown in (c) of FIG. 23 is obtained.

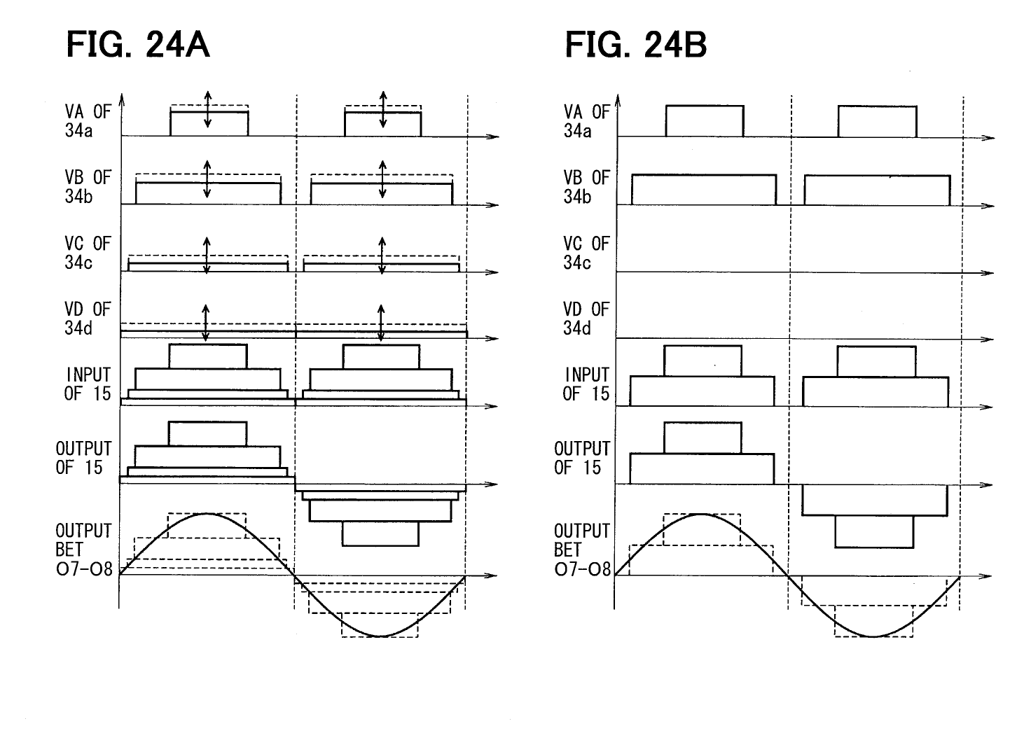

FIGS. 24A and 24B show an example of a control method when the output electricity from the solar cell panel is changed temporally under a condition that the MPPT control is executed. FIG. 24A shows a waveform in a normal time, and FIG. 24B shows a waveform when the electricity generation of the solar cell panels 2c, 2d is zero. In FIGS. 24A and 24B, the pulse width of the pulse voltage as the single pulse rectangular wave is fixed, and the voltage amplitude of the single pulse rectangular wave is controlled to increase and decrease.

Specifically, in, the normal time, when the voltage conversion elements 34a-34d execute the MPPT control according to the control signals of the control circuits 4a-4d, respectively, the amplitude of the pulse voltage is controlled to increase and decrease under a condition that the pulse width of the pulse voltage as the single pulse rectangular wave is set to be a predetermined width. Thus, the maximum electricity of each solar cell panel 2a-2d is obtained according to the MPPT control.

For example, when the weather is suddenly changed, and only the light receiving regions of the solar cell panels 2c, 2d are shadowed, the electricity generation of the solar cell panels 2c, 2d is almost zero. In this case, since the electricity generation of the solar cell panels 2a, 2b is not changed, the voltage conversion elements 34a, 34b functions to maintain the maximum electricity point of the solar cell panels 2a, 2b. In accordance with the operation of the MPPT control, the voltage conversion elements 34a, 34b automatically increase the output.

The reason of the above operation is as follows. The voltage conversion elements 34a, 34b accumulate the generated electricity of the solar cell panels 2a, 2b temporarily in the reactor. L3a, L3b, respectively. Then, the elements 34a, 34b discharges the electricity to the output side. Since the energy accumulated in the reactors L3a, L3b is controlled by the MPPT control method, the energy corresponding to the maximum electricity of the solar cell panels 2a 2b is accumulated. When the MPPT control is executed, the voltage conversion elements 34a, 34b maintain the maximum electricity point. Thus, accumulated energy in the reactor L3a, L3b is discharged. Since the voltage conversion elements 34a, 34b discharges the accumulated electricity, the elements 34a, 34b automatically increases the voltage and decrease the current at the output side. Thus, the electricity is output between the output terminals O7, O8 through the polarity conversion element 15, the waveform shaping element 40 and the AC filter 6, 7, C3, and the pseudo sine wave is shaped based on only the generated electricity of the solar cell panels 2a, 2b, as shown in (b) of FIG. 24.

Here, the control circuits 4a, 4b may independently control the electricity generation of the solar cell panels 2a-2b with the MPPT control method. Alternatively, the control circuits 4a, 4b may execute the MPPT control with receiving the information about the electricity generation amount successively from the control circuits 4c, 4d, which are connected to the control circuits 4a, 4b via the communication line 5. Accordingly, even if only the light receiving regions of the solar cell panels 2c, 2d is shadowed, the electricity generation performance of the solar cell panels 2a, 2b is maintained, and the control circuits 4a, 4b execute the MPPT control, so that the pseudo sine wave is shaped.

### Fifth Embodiment

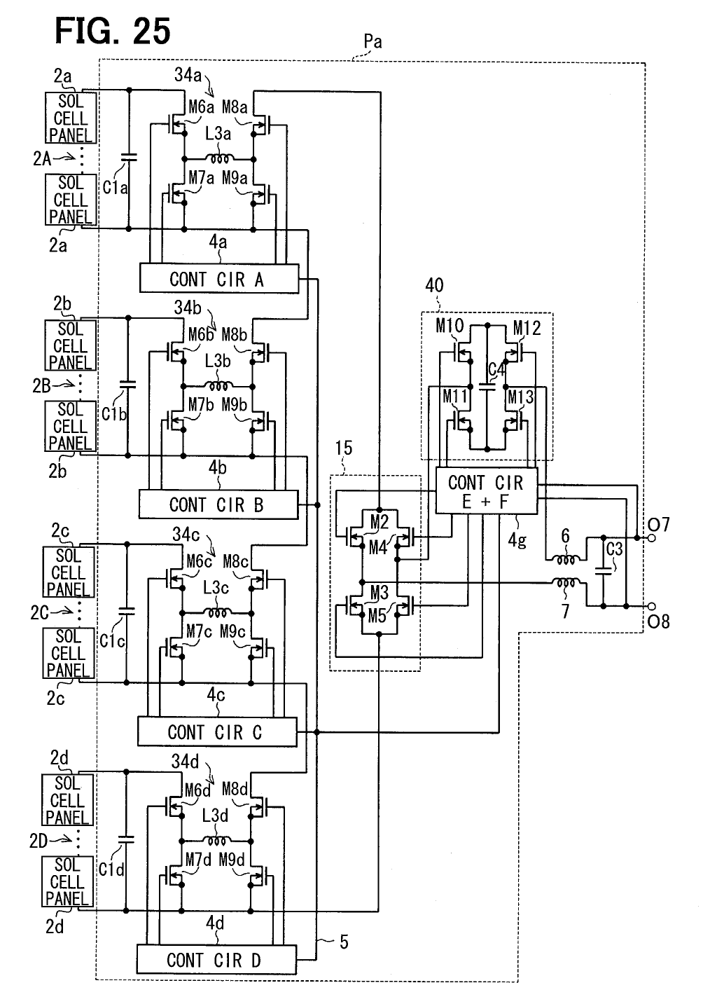

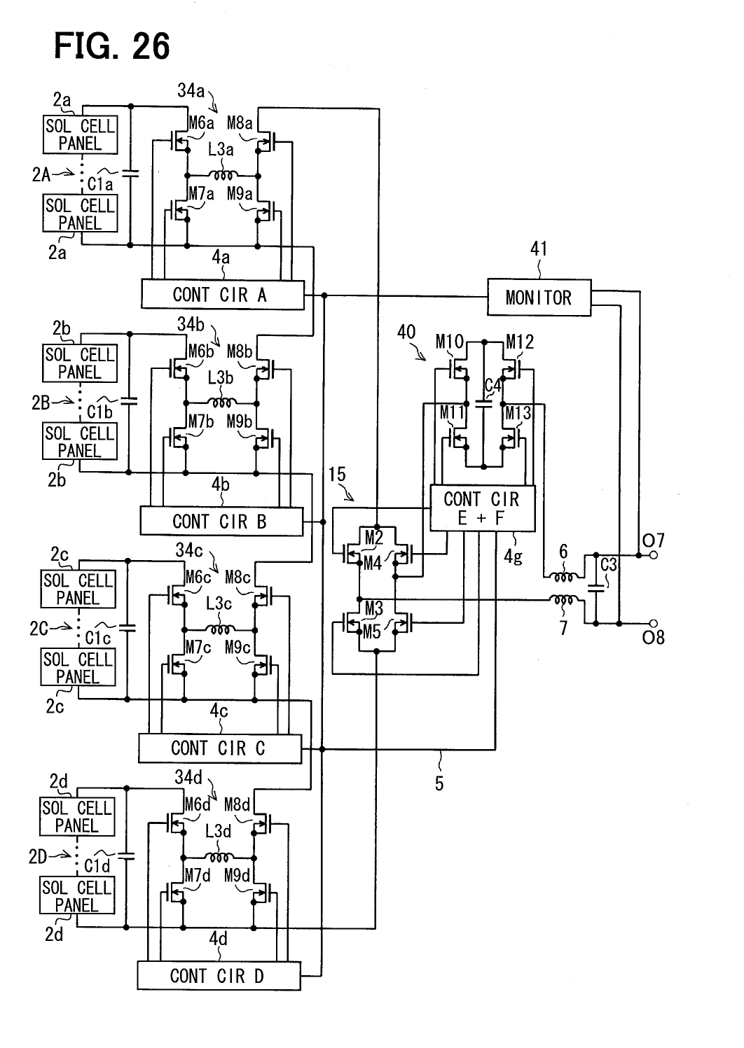

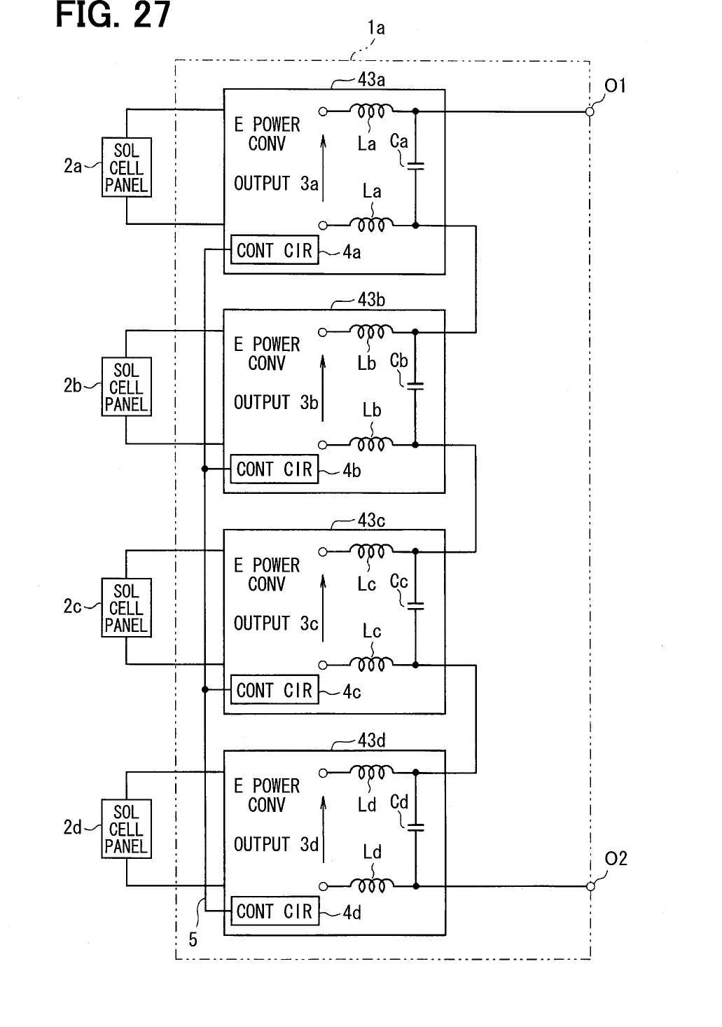

FIGS. 25 and 26 show a solar power conditioner according to a fifth embodiment. A difference between the present embodiment and the above embodiments is such that multiple solar cell panels are connected in series with each other, and the panel group is arranged in each electric power converter. Further, one polarity conversion element and one waveform shaping element are arranged at a whole of the series connection of multiple electric power converters. Furthermore, multiple electric power converters are integrated into one unit in accordance with multiple panel groups.

As shown in FIG. 25, the solar cell panels 2a provide the panel group 2A, and panels 2a are connected in series with an input terminal of the voltage conversion element 34a. Similarly, each of the panels 2b-2d are connected in series with an input terminal of the voltage conversion element 34b-34d, so that the panels 2b-2d provide the panel group 2B-2D.

As described in the above embodiments, the solar cell panel 2a generates the DC voltage of a few volts to a few tens volts. For example, four voltage conversion elements 34a-34d are connected in series with each other, so that a target alternating current voltage is set to be the output of the 200 VAC system. The maximum amplitude of the target alternating current voltage is calculated by multiplying 200 and a square root of 2, so that the maximum amplitude is 282.8 volts. Thus when one panel of the solar cell panel 2a outputs the direct current voltage of 15 volts, five panels of each solar cell panel 2a-2d are connected in series with each other, the solar cell panel 2a-2d connecting to the input terminal of the voltage conversion element 34a-34d.

Specifically, one electric power converter 3a outputs the voltage of 75 volts which is calculated by multiplying 15 as the series voltage of one panel and 5 as the number of panels. When four electric power converters 3a-3d are connected in series with each other, the output voltage is calculated by multiplying 75 volts and four as the number of converters, so that the output voltage is 300 VDC. Thus, it is sufficient to secure the voltage larger than 282.8 volts.

In the present embodiment, the apparatus Pa includes the voltage conversion elements 34a-34d, the polarity conversion element 15, the waveform shaping element 40 and the control circuits 4a-4d, 4g, which are integrated into one unit. Thus, the apparatus Pa outputs the pseudo sine wave between the output terminals O7, O8 when the panel groups 2A-2D are connected. For example, as shown in FIG. 8, the voltage conversion elements 34a-34d cooperate with each other and output the pseudo sine wave so that the output voltages VA-VD of the electric power converters 34a-34d are obtained.

When the apparatus Pa has the electric construction in FIG. 25, the control circuits 4a-4d, 4g cooperate with each other, and the voltage conversion elements 34a-34d output the voltage. When the circuits 4a-4d, 4g execute the cooperation control, the circuits 4a-4d, 4g can execute a parallel process. The control circuit for managing these controls is preliminary determined. The managing control circuit mainly executes a whole of the controls. When the apparatus Pa is the integrated one unit according to the present embodiment, the control circuit 4g for controlling the waveform shaping element 40 and the polarity conversion element 15 at the last step may be the managing control circuit.

The reason why the control circuit 4g is the managing control circuit is as follows. Since the control circuit 4g detects the voltage between the output terminals O7, O8 so that the control circuit 4g executes the feedback control, the control circuit 4g can input the control instructions into the control circuits 4a-4d, respectively, and further, the control circuit 4g easily shapes the waveform of the output voltage of each voltage conversion element 34a-34d.

Further, as shown in FIG. 26, alternatively, a monitor 41 may be arranged independently from the control circuit 4g. The monitor 41 is connected to the communication line 5, so that the monitor 41 detects the voltage between the output terminals O7, O8. Further, the monitor 41 transmits the detection voltage information to each control circuit 4a-4d, 4g. The monitor 41 may provide the function of the managing control circuit. In this case, the monitor 41 outputs the managing control information to each control circuit 4a-4d, 4g, so that each control circuit 4a-4d, 4g can execute the control according to the managing control information. In the present embodiment, since the control circuit 4g or the monitor 41 manages the conversion electricity of multiple electric power converters 3a-3d, the electric power conversion efficiency is improved.

### Sixth Embodiment

FIG. 27 shows a solar power conditioner according to a sixth embodiment. In the first embodiment, two reactors 6, 7 are arranged for a whole output of the solar power conditioner 1. In the solar power conditioner 1a in FIG. 27, each electric power converter 43a-43d provide the electric construction of the electric power converter 3a-3d. Each reactor La-Ld and each capacitor Ca-Cd may be arranged after the output of the electric power converter 3a-3d. In this case, the solar power conditioner is outputs the pseudo sine wave, and further outputs the target alternating current voltage between the output terminals O1, O2.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A solar power conditioner comprising:
a synchronous controller; and
a plurality of electric power converters connected in series with each other, the electric power converters being arranged at a plurality of panel groups, each of which includes one or more solar cell panels, respectively,
wherein each electric power converter executes a maximum power point tracking control for tracking a maximum power point of an output electric power of the panel group,
wherein each electric power converter converts a voltage and a current of the output electric power of the panel group, and
wherein the synchronous controller synchronously controls the plurality of electric power converters to superimpose converted voltages in series, the converted voltages outputting from the electric power converters, so that the plurality of electric power converters output a predetermined pseudo sine wave voltage or a predetermined alternating current voltage.

2. The solar power conditioner according to claim 1,
wherein each electric power converter converts the voltage of the output electric power of the panel group to be at least one of a pulse voltage and a short pulse voltage,
wherein the pulse voltage has a constant voltage during a predetermined time interval, and provides a part of a stepwise voltage,
wherein the short pulse voltage includes a plurality of pulses having a cycle shorter than the pulse voltage so that the short pulse voltage provides a part of the pseudo sine wave voltage,
wherein each electric power converter further includes a polarity conversion element for converting a polarity of the converted voltage, and
wherein the synchronous controller controls each polarity conversion element to convert the polarity of the at least one of the pulse voltage and the short pulse voltage, so that the plurality of electric power converters output the predetermined pseudo sine wave voltage.

3. The solar power conditioner according to claim 1,
wherein each electric power converter includes a switching circuit for turning on and off a transistor, and
wherein each electric power converter changes temporally a duty ratio between an on state and an off state of the transistor so that the electric power converter converts the voltage and the current of the output electric power of the panel group.

4. The solar power conditioner according to claim 1,
wherein each electric power converter includes a switching circuit for turning on and off a transistor, and
wherein each electric power converter changes temporally a frequency between an on state and an off state of the transistor so that the electric power converter converts the voltage and the current of the output electric power of the panel group.

5. The solar power conditioner according to claim 1,
wherein each electric power converter includes a switching circuit for turning on and off a transistor, and
wherein each electric power converter changes temporally a duty ratio and a frequency between an on state and an off state of the transistor so that the electric power converter converts the voltage and the current of the output electric power of the panel group.

6. The solar power conditioner according to claim 1,
wherein the synchronous controller controls each electric power converter in such a manner that, when the converted voltage of one of the electric power converters is reduced, the synchronous controller controls all of other electric power converters to increase the converted voltages of all of other electric power converters.

7. The solar power conditioner according to claim 1,
wherein each electric power converter maintains a value of the converted voltage, and changes a time width of outputting of the converted voltage, so that the electric power converter converts the output electric power of the panel group.

8. The solar power conditioner according to claim 1,
wherein each electric power converter maintains a time width of outputting of the converted voltage, and changes a value of the converted voltage, so that the electric power converter converts the output electric power of the panel group.

9. The solar power conditioner according to claim 2,
wherein a burden share of the pulse voltage and the short pulse voltage, which are output from each electric power converter, is preliminary determined in each electric power converter.

10. The solar power conditioner according to claim 1,
wherein, when one of the electric power converters detects that one of the panel groups corresponding to the one of the electric power converters is shadowed, the synchronous controller stops functioning the one of the electric power converters, and functions only other electric power converters for converting the output electric power of the panel groups, which are not shadowed.

11. The solar power conditioner according to claim 1, further comprising:
only one polarity conversion element for converting a polarity of the converted voltage,
wherein the only one polarity conversion element is arranged at a whole of the plurality of electric power converters.

12. The solar power conditioner according to claim 2, further comprising:
only one waveform shaping element for shaping the stepwise voltage and the pseudo sine wave voltage to be the predetermined alternating current voltage,
wherein the only one waveform shaping element is arranged at a whole of the plurality of electric power converters.

13. The solar power conditioner according to claim 2, further comprising:
only one polarity conversion element for converting a polarity of the converted voltage; and
only one waveform shaping element for shaping the stepwise voltage and the pseudo sine wave voltage to be the predetermined alternating current voltage,
wherein the only one polarity conversion element and the only one waveform shaping element are arranged at a whole of the plurality of electric power converters.

14. The solar power conditioner according to claim 1,
wherein the synchronous controller and the plurality of electric power converters are integrated into one unit.

15. The solar power conditioner according to claim 1,
wherein the synchronous controller includes a plurality of control circuits, each of which controls the electric power converter,
wherein the plurality of control circuits communicate with each other so that the plurality of control circuits control the electric power converters in a coordinated manner.

16. The solar power conditioner according to claim 1,
wherein the synchronous controller further includes a managing control circuit for controlling a whole of the electric power converters in order to manage the converted voltages.
